(19) United States
(12) Patent Application Publication
(10) Pub. No.: US 2025/0353113 A1
(43) Pub. Date: Nov. 20, 2025

(54) POUCH SEALING DEVICE USING LASER

(71) Applicant: K2 LASER SYSTEM INC., Anyang-si (KR)

(72) Inventors: MYOUNG SOO KIM, Anyang-si (KR); Yeoungcheol KIM, Anyang-si (KR); Ko Dong PARK, Anyang-si (KR); Jae Hyok KIM, Anyang-si (KR); Jooho JUNG, Anyang-si (KR)

(21) Appl. No.: 19/054,878

(22) Filed: Feb. 16, 2025

(30) Foreign Application Priority Data
May 17, 2024 (KR) 10-2024-0064498
Jun. 20, 2024 (KR) 10-2024-0080365

(51) Int. Cl. B23K 26/21; G02B 6/42; H01M 10/04; H01M 50/105; H01M 50/197

(52) U.S. Cl. CPC B23K 26/21; G02B 6/4206; G02B 6/421; H01M 10/0404; H01M 50/105; H01M 50/197

(57) ABSTRACT

The present disclosure relates to a pouch sealing device using a laser that heat-fuses a pouch of a pouch-type secondary battery, and to this end, the present disclosure discloses a pouch sealing device using a laser comprising a first pouch having a first insulating layer, a first metal layer, and a first sealing layer, and a second pouch having a second insulating layer, a second metal layer, and a second sealing layer, the first sealing layer of the first pouch and the second sealing layer of the second pouch may be heat-fused each other, the pouch sealing device may comprise a first waveguide pressurizing the first pouch and having a first waveguide region and a first laser bundle array being coupled to the first waveguide and supplying the laser through the first waveguide region so that the first and second sealing layers are heat-fused each other to be sealed.

### CROSS-REFERENCE TO RELATED APPLICATION(S)

This application claims priority to Korean Patent Application Nos. 10-2024-0064498 filed on May 17, 2024 and 10-2024-0080365 filed on Jun. 20, 2024 in the Korean Intellectual Property Office, the disclosure of which is incorporated by reference herein in its entirety.

### TECHNICAL FIELD

The present disclosure relates to a pouch sealing device using a laser.

### DISCUSSION OF RELATED ART

In recent years, the types of devices that use batteries have increased, and accordingly, the demand for high-capacity and high-density batteries is increasing. Among them, lithium ion secondary batteries with high energy density and discharge voltage are commercialized and used in various forms.

Lithium ion secondary batteries are classified into cylindrical secondary batteries, square secondary batteries, and pouch-type secondary batteries depending on their appearance. Among these, for pouch-type secondary batteries, the thickness of the aluminum laminate sheet can be controlled to obtain a high-capacity and high-density secondary battery, and they can have various shapes, so research is being conducted in various fields.

The pouch-type secondary batteries are formed, typically by forming an aluminum laminate sheet to form a storage part, storing an electrode assembly in the storage part, and then sealing the periphery of the storage part. In a conventional pouch-type secondary battery sealing device, pressurization and heating are performed by a single member to seal the periphery of the storage part to form a sealing part.

For example, in a pouch-type secondary battery sealing device according to the prior art, sealing parts of a pouch-type secondary battery case made of a laminate sheet including an outer resin layer, a metal layer, and an inner sealant layer are arranged so that the inner sealant layers face each other, and then sealed by placing them between pressurizing parts capable of simultaneously performing heating and pressurization. However, the pouch-type secondary battery sealing device according to the prior art had a problem in that it took a long time for heat to be transferred from the outer resin layer to the inner sealant layer, and thus the outer resin layer was damaged.

The information disclosed in the background of the present disclosure is only for improving understanding of the background of the present disclosure and therefore may include information that does not constitute prior art.

### SUMMARY

The issue to be addressed by the present disclosure is to provide a sealing device that heat-fuses a pouch (outer case) using a laser. Further, the present disclosure is to provide a sealing device that minimizes wrinkles in a pouch due to thermal change without external damage (trace) through uniform energy irradiation. Further, the present disclosure is to provide a sealing device that realizes a processing line of a constant width and thickness by simply replacing a mold, even if the internal structure of the pouch is changed. Further, the present disclosure is to provide a sealing device that implements a non-lifting joint because a mold-integrated waveguide pressurizes the pouch and heat-fuses the pouch.

The pouch sealing device using a laser according to the present disclosure may comprise a first pouch having a first insulating layer, a first metal layer, and a first sealing layer, and a second pouch having a second insulating layer, a second metal layer, and a second sealing layer, the first sealing layer of the first pouch and the second sealing layer of the second pouch may be heat-fused each other, the pouch sealing device may comprise a first waveguide pressurizing the first pouch and having a first waveguide region and a first laser bundle array being coupled to the first waveguide and supplying the laser through the first waveguide region so that the first and second sealing layers are heat-fused each other to be sealed.

In one or more embodiments, the first waveguide may comprise a flat upper side and a flat lower side opposite the upper side and in close contact with the first insulating layer of the first pouch, the first waveguide region may penetrate the upper side and the lower side, and the lower opening width of the first waveguide region may be smaller than the upper opening width of the first waveguide region.

In one or more embodiments, the upper opening may have a width of 1 mm to 7 mm and the lower opening may have a width of 0.5 mm to 5 mm.

In one or more embodiments, the first laser bundle array may include a first incident fiber onto which a laser is incident from a laser generating device, a plurality of second emission fibers coupled to the first incident fibers through a first coupler, and a plurality of first legs coupled to the first waveguide region while being coupled to the second emission fibers, respectively.

In one or more embodiments, the device may further comprise a first micro lens and a first cylinder lens coupled to the first waveguide region.

In one or more embodiments, the laser may have a wavelength of 700 nm to 1100 nm.

In one or more embodiments, the device may further comprise a second waveguide pressurizing the second pouch and having a second waveguide region; and a second laser bundle array being coupled to the second waveguide and supplying a laser through the second waveguide region so that the first and second sealing layers are heat-fused to each other to be sealed.

In one or more embodiments, the device may further comprise a distance sensor for sensing the sealing distance between the first waveguide and the second waveguide after the sealing, a non-contact pouch sealing device may determine that the sealing has been performed to have an optimal sealing strength if the distance sensed by the distance sensor is within a preset reference distance range, it may determine that weak sealing has been performed if the distance sensed by the distance sensor is greater than the preset reference distance range, and it may determine that over-sealing has been performed if the distance sensed by the distance sensor is less than the preset reference distance range.

The present disclosure provides a sealing device that heat-fuses a pouch (outer case) using a laser. Further, the present disclosure provides a sealing device that minimizes wrinkles in a pouch due to thermal change without external damage (trace) through uniform energy irradiation. Further, the present disclosure provides a sealing device that realizes a processing line of a constant width and thickness by simply replacing a mold, even if the internal structure of the pouch is changed. Further, the present disclosure provides a sealing device that implements a non-lifting joint because a mold-integrated waveguide pressurizes the pouch and heat-fuses the outer case.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exploded view of an exemplary pouch-type secondary battery sealed by a sealing device according to the present disclosure;

FIG. 2 is a block diagram illustrating an electrical configuration of a pouch sealing device using a laser according to the present disclosure;

FIG. 3 is a schematic view illustrating a bundle array of the pouch sealing device using a laser according to the present disclosure;

FIG. 4 is a view illustrating a beam shaping method of the pouch sealing device using a laser according to the present disclosure;

FIG. 5A and FIG. 5B are a perspective view and cross-sectional view, respectively, illustrating a mold-integrated waveguide to which a bundle array of the pouch sealing devices using a laser according to the present disclosure is combined;

FIG. 6 is a cross-sectional view illustrating a sealing state by a pouch sealing device using a laser according to the present disclosure;

FIG. 7 is a cross-sectional view illustrating a sealing state by a pouch sealing device using a laser according to the present disclosure;

FIG. 8 is a cross-sectional view showing the sealing state and the post-sealing state by a pouch sealing device using a laser according to the present disclosure; and

FIG. 9 is a graph showing the optimal sealing area by a pouch sealing device using a laser according to the present disclosure.

### DETAILED DESCRIPTION OF EXEMPLARY EMBODIMENTS

Hereinafter, preferred embodiments according to the present disclosure are described in detail with reference to the accompanying drawings.

The present disclosure is provided to more completely explain the present disclosure to those skilled in the art, and the following examples may be modified into various other forms, and the scope of the present disclosure is not limited to the following examples. Rather, these examples make the disclosure more complete and is provided in order to completely convey the spirit of the present disclosure to those skilled in the art.

Further, in the following drawings, the thickness and size of each layer are exaggerated for convenience and clarity of description, and the same symbols in the drawings refer to the same elements. As used herein, the term “and/or” includes any one and all combinations of one or more of the listed items. Further, as used herein, the term “connected” refers not only to the case where member A and member B are directly connected, but also to the case where member C is interposed between member A and member B to indirectly connect member A and member B.

The terms used herein are used to describe specific embodiments and are not intended to limit the invention. As used herein, the singular forms include the plural forms unless the context clearly indicates otherwise. Additionally, as used herein, the terms “comprise, include,” and/or “comprising, including” specify the presence of stated shapes, numbers, steps, operations, members, elements and/or groups thereof but is not intended to exclude the presence or addition of one or more other shapes, numbers, operations, members, elements and/or groups thereof.

As used herein, the terms “first,” “second,” etc. are used to describe various members, parts, regions, layers and/or parts, but it is obvious that these members, parts, regions, layers and/or parts should not be limited by these terms. These terms are used only to distinguish one member, component, region, layer or part from another member, component, region, layer or part. Accordingly, a first member, component, region, layer or part described below may refer to a second member, component, region, layer or part without departing from the teachings of the present disclosure.

Space-related terms such as “beneath,” “below,” “lower,” “above,” and “upper” may be used to facilitate understanding of one element or feature and another element or feature shown in the drawings. These space-related terms are for easy understanding of the present disclosure according to various process states or usage states of the present disclosure, and are not intended to limit the present disclosure. For example, if an element or feature in a drawing is inverted, an element or feature described as “beneath” or “below” becomes “above” or “upper.” Therefore, “below” is a concept encompassing “above” or “below.”

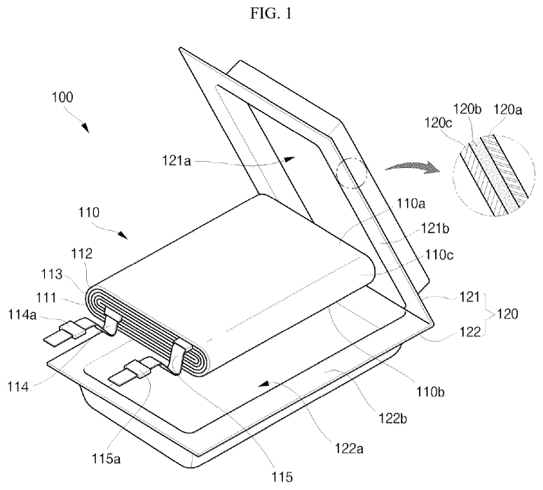

FIG. 1 is an exploded view of an exemplary pouch-type secondary battery sealed by a sealing device according to the present disclosure. Here, the pouch-type secondary battery 100 illustrated is only an example for understanding the present disclosure, and the present disclosure is not limited to sealing such a pouch-type secondary battery. The present disclosure may be used in various fields such as sealing of pouches for packaging goods in addition to pouch type secondary batteries 100.

As illustrated in FIG. 1A and FIG. 1B, an exemplary pouch-type secondary battery 100 may include an electrode assembly 110 and a pouch outer case 120.

The electrode assembly 110 may include a negative electrode plate, a positive electrode plate, and a separator interposed between the negative electrode plate and the positive electrode plate. This electrode assembly 110 may be in the form of a stack of a negative electrode plate, a separator, and a positive electrode plate, or in the form of a jelly roll, and the structure is general, so a detailed description is excluded.

The negative electrode plate may include, but is not limited to, a negative active material layer coated on both sides of a negative electrode current collector plate made of a conductive metal sheet, for example, copper or nickel foil or mesh. Here, the negative active material layer may include, but is not limited to, carbon series materials, Si, Sn, tin oxide, tin alloy complex, transition metal oxide, lithium metal nitrite or metal oxide, etc. On the negative electrode non-coated part where the negative electrode active material layer may not formed on the negative electrode collector plate, a generally flat negative electrode tab 114 may be fixed (e.g., welded), but is not limited thereto. One end of the negative electrode tab 114 may be electrically connected to the negative electrode non-coated part, and the other end may protrude and extend externally, and an insulating member 114a may be attached to the negative electrode tab 114, so as to prevent the negative electrode tab 114 from being short-circuited with the pouch outer case 120.

The positive electrode plate 112 may include, but is not limited to, a positive electrode active material layer coated on both sides of a positive electrode current collector plate made of a metal sheet with excellent conductivity, for example, aluminum foil or mesh. Here, the positive electrode active material layer is not limited, but a chalcogenide compound can be used, and for example, composite metal oxides such as LiCoO₂, LiMn₂O₄, LiNiO₂, and LiNiMnO₂ may be used. On the positive electrode non-coated part where the positive electrode active material layer is not formed on the positive electrode collector plate, a positive electrode tab 115 may be fixed (e.g., welded). Further, an insulating member 115a may be attached to the positive electrode tab 115, so as to prevent the positive electrode tab 115 from being short-circuited with the pouch outer case 120.

A separator may be interposed between the negative and positive electrode plates to prevent electrical shorts between the negative and positive electrode plates. In practice, a pair of separators may be provided, and the negative electrode plate may be sandwiched between these pair of separators. Additionally, the separator may be formed of, but is not limited to, any one selected from the group consisting of polyethylene, polypropylene, and porous copolymers of polyethylene and polypropylene. The separator may be formed to have a wider width than the negative and positive electrode plates to prevent electrical shorts between the negative and positive electrode plates.

The pouch outer case 120 may accommodate the electrode assembly 110 and be formed by sealing the outer periphery of the electrode assembly 110. The pouch outer case 120 may substantially include a first outer part 121 and a second outer part 122 connected at one end to the first outer part 121. Furthermore, the first outer part 121 may include a first receiving part 12la that receives one side of the electrode assembly 110, and the second outer part 122 may include a second receiving part 122a that receives the other side of the electrode assembly 110. Here, only one of the first and second storage parts 121a, 122a may be formed, and of course, if the electrode assembly 100 is thin, neither may be formed.

In addition, the sealing parts 121b, 122b of the periphery or surroundings of the first and second outer parts 121, 122 corresponding to the outer periphery of the electrode assembly 110 may be sealed (e.g., by heat welding) each other, so that the electrode assembly 110 may be accommodated in the inner side of a pouch outer case 120 of approximately a pouch or pocket type. That is, the pouch outer case 120 may be formed by folding the pouch outer case 120 in the shape of a square plate formed integrally in the approximate middle based on the length direction of one side to form the first outer part 121 and the second outer part 122. Further, the first and second outer parts 121, 122 may be formed with the first and second receiving part (or cavity) 121a, 122a of a certain depth that can accommodate an electrode assembly 110 through a press or drawing process, etc., and the sealing parts 121b, 122b for mutual sealing of the first and second outer parts 121, 122 may be formed on the outer periphery of the first and second receiving parts 121a, 122a. The sealing parts 121b, 122b may be entirely formed along one side and the remaining three sides of the first and second outer parts 121, 122.

Meanwhile, the negative electrode tab 114 and the positive electrode tab 115 of the electrode assembly (110) may be pulled outward through the area where the first and second outer parts 121, 122 are sealed (fused). At this time, the insulating members 114a, 115b formed on the negative electrode tab 114 and the positive electrode tab 115, respectively, may be sealed together with the sealing parts 121b, 122b. That is, the insulating members 114a, 115b may be formed at the part where the negative electrode tab 114 and the positive electrode tab 115 and the sealing parts 121b, 122b come into contact, thereby preventing the negative electrode tab 114 and the positive electrode tab 115 from being electrically short-circuited with the pouch outer case 120.

The pouch outer case 120 may be formed as a multilayer or laminate structure having, but is not limited to, a first insulating layer 120a, a metal layer 120b, and a second insulating layer 120c. Of course, various adhesive layers or functional layers may be added in addition to this, but a description thereof is excluded so as not to obscure the gist of the present disclosure. In the following description, the pouch outer case 120 may be simply referred to as a pouch or an outer case.

The first insulating layer 120a may be the outer surface of the pouch outer case 120 and serve to cushion mechanical and chemical impacts with external electronic devices. In addition, the first insulating layer 120a may be formed on the outer surface of the metal layer 120b and form the outer surface of the pouch outer case 120. The first insulating layer 120a may be formed of, but is not limited to, nylon, polyethylene terephthalate (PET), polybutylene terephthalate (PBT), polybutylene naphthalate (PBN), or an equivalent thereof.

The metal layer 120b may be interposed between the first insulating layer 120a and the second insulating layer 120c and serve to prevent moisture and oxygen from flowing in from the outside, and if an electrolyte is filled inside the pouch outer case 120, prevent its leakage to the outside. Further, the metal layer 120b may play a role in maintaining the mechanical strength of the pouch outer case 120. Generally, the metal layer 120b may be formed of, but is not limited to, aluminum, an aluminum alloy, iron, or an iron alloy.

The second insulating layer 120c may be the inner surface of the pouch outer case 120 and may be formed of a material having insulating and thermal adhesive properties. In addition, the second insulating layer 120c may be formed on the inner surface of the metal layer 120b and may form the inner surface of the pouch outer case 120 facing the electrode assembly 110. The second insulating layer 120c may be formed of, but is not limited to, a cast polypropylene film, a modified polypropylene film, or an equivalent thereof that does not react with an electrolyte, etc. When the electrode assembly 110 is accommodated in the first and second receiving parts 121a, 122a of the first and second outer parts 121, 122, respectively, and the first and second outer parts 121, 122 are folded, the second insulating layers 120c of the first and second outer parts 121, 122 come into contact with each other. Therefore, when the sealing parts (121b, 122b) are heat-fused, the second insulating layers 120c of the first and second outer parts 121, 122 are bonded to each other, sealing the pouch outer case (120). In the following description, the second insulating layer 120c may also be referred to as a sealing layer, a heat-fused layer, a sealant layer, or a cast polypropylene (CPP) layer.

Meanwhile, although the pouch-type secondary battery described herein is illustrated with the positive and negative electrode tabs protruding and extending in the same direction, the positive and negative electrode tabs may protrude and extend in opposite directions depending on the needs of the external set, and the widths of the positive and negative electrode tabs may also be wider than illustrated. Accordingly, the shape of the sealing part provided on the pouch outer case may be changed depending on the protrusion and extension direction or width of the positive and negative electrode tabs.

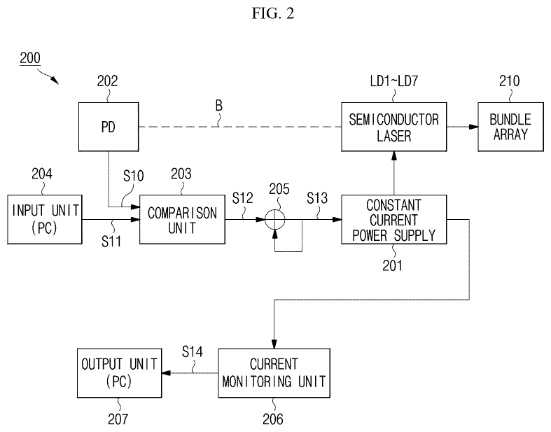

FIG. 2 is a block diagram illustrating an electrical configuration of a pouch sealing device using a laser 200 according to the present disclosure. As shown in FIG. 2, the pouch sealing device using a laser 200 according to the present disclosure may comprise at least one of a constant current power supply 201 that drives semiconductor lasers LD1 to LD7, a photodetector (PD) 202 that detects the optical output of a laser beam B emitted from the semiconductor lasers LD1 to LD7 and provided to a bundle array 210, a comparison unit 203 that receives an output signal S10 of the photodetector 202, an input unit 204 that inputs an optical output setting signal S11 to the comparison unit 203, an adding unit 205 that receives an output signal S12 of the comparison unit 203, a current monitoring unit 206 that monitors the current value supplied to the semiconductor lasers LD1 to LD7 by the constant current power supply 201, and an output unit that receives output signal S14 of the current monitoring unit 206.

The input unit 204 and the output unit 207 may be configured, for example, with a personal computer (PC). The photodetector 202 may be installed in a location that is not affected by heat generated by the semiconductor lasers LD1 to LD7 so as to exhibit no change in characteristics due to heat. Although multiple semiconductor lasers LD1 to LD7 are illustrated in FIG. 2, those skilled in the art will appreciate that one may also be provided.

The constant current power supply 201 may drive semiconductor lasers LD1 to LD7 by a supplied predetermined current. At this time, the predetermined current is specified by the initial value of the driving current setting signal S13 output by the adding unit 205. The current may be set to a value that can obtain the normal optical output required for sealing by semiconductor lasers LD1 to LD7.

A laser beam may be provided from semiconductor lasers LD1 to LD7 driven in this manner to a bundle array 210. A part of the provided laser beam may be branched and its optical output may be detected by a photodetector 202. The signal representing the detected optical output S10 may be input to the comparison unit 203. At this time, the optical output setting signal S11 output by the input unit 204 may be input to the comparison unit 203. The optical output setting signal S11 may indicate the optical output of the laser beam required when sealing the pouch outer case.

The comparison unit 203 may output a differential signal S12 obtained by the equation S12=S11−S10. The differential signal S12 may be input to the adding unit 205. When the differential signal S12 is input, the adding unit 205 may add the differential signal S12 to the driving current setting signal S13 that specifies the current value supplied by the constant current power supply 201 to the semiconductor lasers LD1 to LD7. As the addition process is performed continuously at a predetermined cycle, the current supplied by the constant current power supply 201 to the semiconductor lasers LD1 to LD7 may be continuously changed to a value such that S11=S10, that is, the optical output of the laser beam is almost the same as the optical output set by the input unit 204.

The current supplied by the constant current power supply 201 that changes in this manner may be monitored by the current monitoring unit 206. The signal representing this supply current value S14 may be input to the output unit 207. The change in the supply current may be the change when the optical output of the laser beam is controlled to be the same as the set optical output by the input unit 204. Therefore, when the driving current of the semiconductor lasers LD1 to LD7 is changed in a manner similar to the change pattern of the supply current during sealing the pouch outer case, the optical output of the laser beam becomes the optical output value set by the input unit 204 or converges to a value close thereto. Accordingly, the output unit 2017 may provide a current ratio for each elapsed time (T) based on the change pattern of the supply current indicated by this signal S14.

In this way, the pouch sealing device using a laser 200 may provide a laser wavelength range of, for example, approximately 700 nm to approximately 1100 nm. In some examples, the laser wavelength may be in the range of about 750 nm to about 900 nm, and preferably in the range of about 750 nm to about 850 nm. If the wavelength of the laser is too long, it may not be sufficient to induce heat generation in the barrier metal layer or melting of the sealant layer, or it may take a long time, but if the wavelength of the laser is too short, the high energy may cause rupture or fire of the pouch outer case. In addition, due to laser irradiation, the temperature of the sealant layer may rise to, for example, 180° C. to 300° C., causing it to melt. When the temperature range is outside of 180° C. to 300° C., it is practically difficult to form a sealing part due to insufficient or excessive melting.

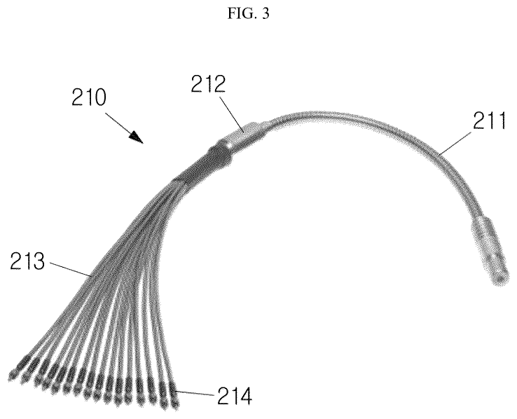

FIG. 3 is a schematic view illustrating a bundle array 210 of the pouch sealing device using a laser 200 according to the present disclosure. As shown in FIG. 3, the bundle array 210 may include at least one of an incident fiber 211 into which a laser beam is incident from a laser light source, i.e., the semiconductor lasers LD1 to LD7 described above, a plurality of output fibers 213 coupled to the incident fiber 211 through a coupler 212 to output a plurality of laser beams, and a plurality of legs 214 coupled to the plurality of output fibers 213, respectively, and coupled to a waveguide 220. That is, legs 214 are connected to the ends of a plurality of emission fibers 213 so that a laser can be provided to the waveguide through the plurality of legs 214. In some examples, spatially different heat distributions can be implemented by differently controlling the output intensities of beams provided from multiple semiconductor lasers LD1 to LD7. Here, the output intensities of multiple semiconductor lasers LD1 to LD7 may be determined by the current as described above. As described above, the output of the semiconductor lasers LD1 to LD7 may be controlled differently or identically.

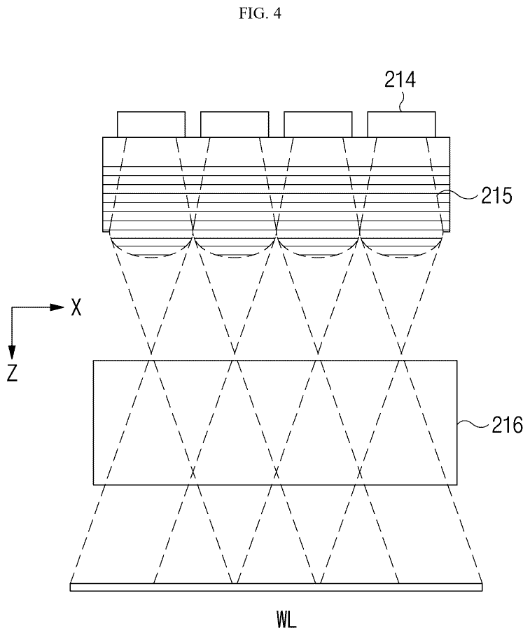

FIG. 4 is a view illustrating a beam shaping method of the pouch sealing device using a laser 200 according to the present disclosure. As illustrated in FIG. 4, a plurality of legs 214 may be coupled to the inlet side (e.g., the upper side) of the waveguide 220, and a plurality of micro lens arrays 215 and cylinder lenses 216 may be coupled to the inner side of the waveguide 220, so that the waveguide 220 may output a line beam WL. In some examples, in addition to the micro lens array (215), a square light pipe or a diffractive optical element may be used.

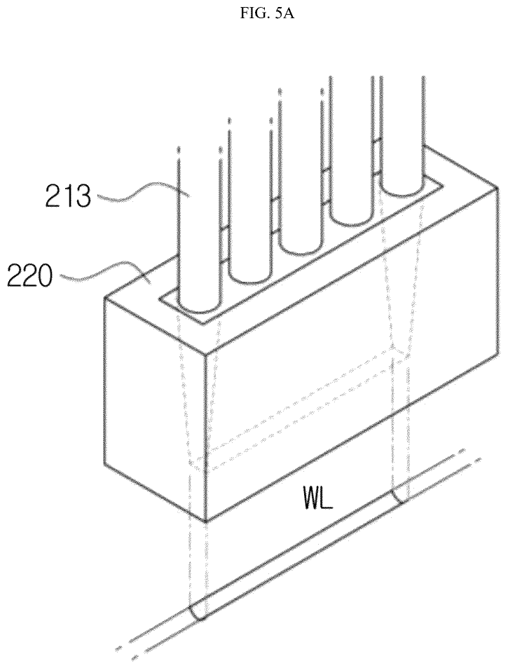

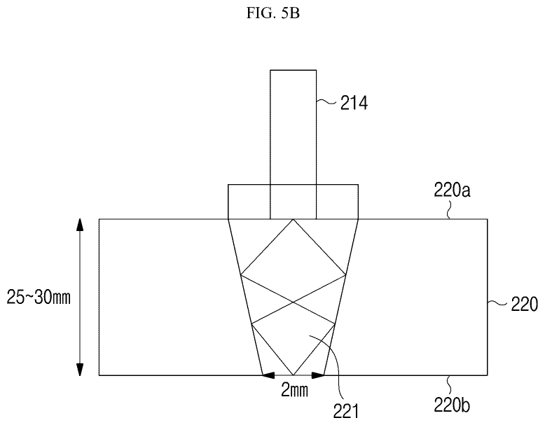

FIG. 5A and FIG. 5B are a perspective view and cross-sectional view, respectively, illustrating a mold-integrated waveguide 220 to which a bundle array 210 of the pouch sealing devices using a laser 200 according to the present disclosure is combined. As illustrated in FIG. 5A and FIG. 5B, an exemplary pouch sealing device 200 according to the present disclosure may include a bundle array 210 and a mold-integrated waveguide 220 that forms a sealing part by combining the bundle array 210 to provide a laser to the pouch.

The mold-integrated waveguide 220 may provide a laser while simultaneously pressurizing the-be-sealed area of the pouch. The waveguide 220 may include a flat upper surface 220a, a flat lower surface 220b that presses the to-be-sealed area of the pouch as the opposite surface of the upper surface 220a, and a waveguide region 221 that penetrates the upper surface 220a and the lower surface 220b.

In some examples, the waveguide region 221 may have a width of the opening in the upper surface 220a wider than a width of the opening in the lower surface 220b. In some examples, the waveguide region 221 may have a cross-sectional shape that is an inverted trapezoid. In some examples, the width of the opening in the lower surface 220b of the waveguide region 221 may be from about 0.5 mm to about 5 mm. In practice, the width of the sealing part may be from about 0.5 mm to about 5 mm. In some examples, the width of the opening in the upper surface 220a of the waveguide region 221 may be from about 1 mm to about 7 mm. In some examples, the height of the waveguide 220 may be from about 10 mm to about 50 mm. The waveguide region 221 may also have a long line shape when viewed from a plane so that the waveguide 220 may emit a line beam.

The bundle array 210 may include a launch fiber 213 and legs 214 coupled to an end of the launch fiber 213 as described above, and the legs 214 may be coupled to an opening in the upper surface 220a of the waveguide 220. The waveguide region 221 of the waveguide 220 has a long line shape when viewed from a plane, and accordingly, the plurality of legs 214 may be coupled to this long waveguide region 221 in a long array in a single row or multiple rows.

As described above, the micro lens array 215 and the cylinder lens 216 may be further combined in the waveguide region 221 for shaping the line beam.

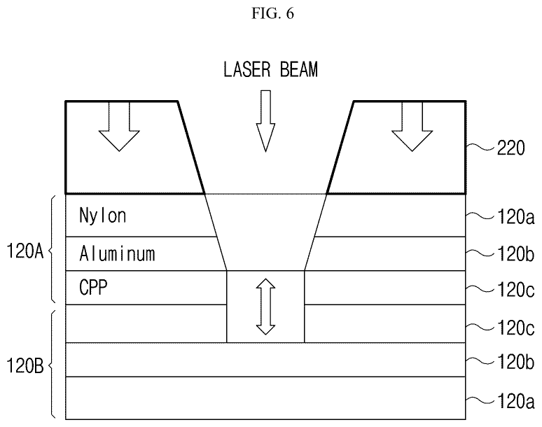

FIG. 6 is a cross-sectional view illustrating a sealing state by a pouch sealing device using a laser 200 according to the present disclosure. As illustrated in FIG. 6, the pouch sealing device using a laser 200 according to the present disclosure may have the mold-integrated waveguide 220 provided only on the upper side of the to-be-sealed area. For example, when an upper pouch 120A having the first insulating layer 120a (e.g., nylon), the metal layer 120b, and the second insulating layer 120c (e.g., a CPP layer) and a lower pouch 120B having the first insulating layer 120a (e.g., nylon), the metal layer 120b, and the second insulating layer 120c (e.g., a CPP layer) are overlapped, the waveguide 220 may pressed only to the upper pouch 120A, and a laser beam can be irradiated through the legs 214.

In this way, the laser may penetrates the first insulating layer 120a and the metal layer 120b of the upper pouch 120A and melt the second insulating layer 120c of the upper pouch 120A and the second insulating layer 120c of the lower pouch 120B. After that, the laser irradiation through the leg 214 is completed, and then the upper second insulating layer 120c and the lower second insulating layer 120c are cooled while becoming one, thereby providing a sealing part between the upper pouch 120A and the lower pouch 120B.

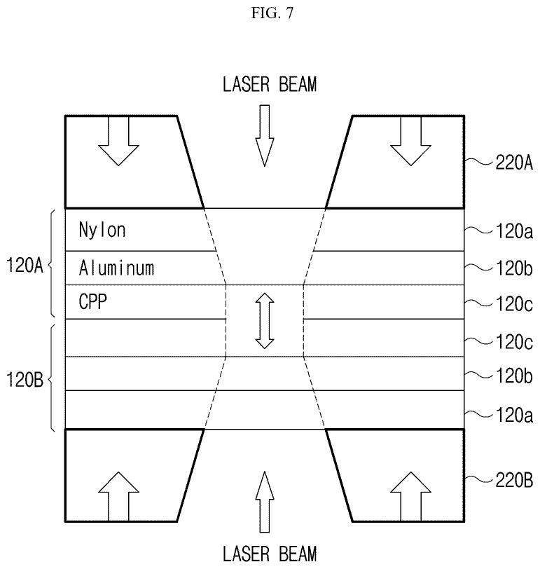

FIG. 7 is a cross-sectional view illustrating a sealing state by a pouch sealing device using a laser 200 according to the present disclosure.

As illustrated in FIG. 7, the pouch sealing device using a laser 200 according to the present disclosure may include an upper mold-integrated waveguide 220A provided on the upper side of an upper pouch 120A and a lower mold-integrated waveguide 220B provided on the lower side of a lower pouch 120B. For example, the upper mold-integrated waveguide 220A may be provided on the upper side of the upper pouch 120A having the first insulating layer 120a, the metal layer 120b, and the second insulating layer 120c, and the lower mold-integrated waveguide 220B may be provided on the lower side of the lower pouch 120B having the first insulating layer 120a, the metal layer 120b, and the second insulating layer 120c. Of course, the upper bundle array may be coupled to the upper mold-integrated waveguide 220A, and the lower bundle array may be coupled to the lower mold-integrated waveguide 220B. In practice, the configuration of the lower mold-integrated waveguide 220B may be identical or similar to the configuration of the upper mold-integrated waveguide 220A.

In this way, the laser from the upper mold-integrated waveguide 220A may penetrate the upper first insulating layer 120a (e.g., nylon) and the metal layer 120b to melt the upper second insulating layer 120c (e.g., CPP layer), and the laser from the lower mold-integrated waveguide 220B may penetrate the lower first insulating layer 120a (e.g., nylon) and the metal layer 120b to melt the lower second insulating layer 120c (e.g., CPP layer). At the same time, the upper mold-integrated waveguide 220A and the lower mold-integrated waveguide 220B may pressurize the upper pouch 120A and the lower pouch 120B between them to fuse the second insulating layers 120c on the upper and lower sides of the pouches 120A, 120B.

After the laser irradiation is completed, the pressurization of the upper and lower mold-integrated waveguides 220A, 220B is maintained, and the upper second insulating layer 120c (e.g., CPP layer) and the lower second insulating layer 120c (e.g., CPP layer) may be cooled while being integrated, thereby providing a sealing part between the upper pouch 120A and the lower pouch 120B.

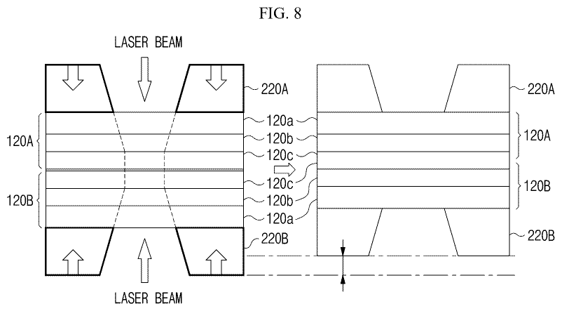

FIG. 8 is a cross-sectional view showing the sealing state and the post-sealing state by a pouch sealing device using a laser 200 according to the present disclosure. As illustrated in FIG. 8, while the upper and lower mold-integrated waveguides 220A, 220B are pressurized, the upper second insulating layer 120c and the lower second insulating layer 120c are melted and bonded to each other by the heat conduction phenomenon of the heated upper metal layer 120b and the heated lower metal layer 120b. Accordingly, the upper second insulating layer (120c) and the lower second insulating layer (120c) become thinner than the thickness before melting. Therefore, the distance between the clamped upper waveguide 220A and the lower waveguide 220B changes, and this is measured to predict the workability of the sealing part.

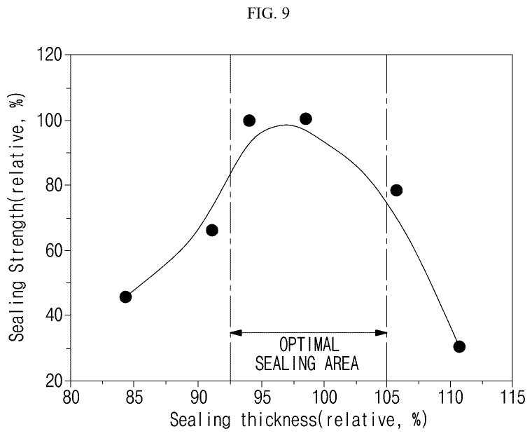

FIG. 9 is a graph showing the optimal sealing area by a pouch sealing device using a laser according to the present disclosure.

In FIG. 9, the X-axis represents the relative sealing thickness (%), and the Y-axis represents the relative sealing strength (%). The graph in FIG. 9 is an example, and the graph for relative sealing thickness versus relative sealing strength may change depending on the material, component ratio, thickness, and environment of the pouch.

As shown in FIG. 9, the sealing strength may be the best in the optimal sealing area. As the sealing thickness becomes relatively thicker (weak sealing area corresponding to the right part of the graph), and as the sealing thickness becomes relatively thinner (excessive sealing area corresponding to the left part of the graph), their sealing strengths may gradually decrease compared to that of the optimal sealing area.

Therefore, in the present disclosure, after the formation of the sealing part, the distance between the upper waveguide 220A and the lower waveguide 220B is sensed to determine whether the sealing state of the sealing part is an optimal sealing state or not.

Based on this, the sealing device 200 according to the present disclosure may further include a distance sensor that senses the sealing distance between the first waveguide 220A and the second waveguide 220B after sealing. In some examples, the distance sensor may be installed on the outside of the first waveguide 220A and the second waveguide 220B to sense the distance between the first and second waveguides 220A, 220B before and after sealing, and transmit the same to the control unit. Then, the sealing device 200, i.e., the control unit, may determines and display that sealing has been performed to have an optimal sealing strength if the distance sensed by the distance sensor is within a preset reference distance range, determine and display that weak sealing has been performed if the distance sensed by the distance sensor is greater than a preset reference distance range, and determine and display that oversealing has been performed if the distance sensed by the distance sensor is less than a preset reference distance range. In some examples, the control unit is further connected to a display unit, so that the control unit can display, through the display unit, the distance before and after sealing, the optimum sealing strength and area, and whether there is a weak seal or an excessive seal.

As mentioned above, the present disclosure may be used in various fields such as sealing of pouches for packaging goods in addition to pouch type secondary.

The above description is only for one embodiment for implementing an exemplary pouch sealing device using a laser according to the present disclosure. The present disclosure is not limited to the above embodiment. As claimed in the claims below, it is understood that the technical spirit of the present disclosure exists to the extent that various changes can be made by those skilled in the art without departing from the gist of the present disclosure.

What is claimed is:

1. A pouch sealing device using a laser comprising a first pouch having a first insulating layer, a first metal layer, and a first sealing layer, and a second pouch having a second insulating layer, a second metal layer, and a second sealing layer, wherein the first sealing layer of the first pouch and the second sealing layer of the second pouch are heat-fused each other, wherein the pouch sealing device comprises a first waveguide pressurizing the first pouch and having a first waveguide region; and
a first laser bundle array being coupled to the first waveguide and supplying the laser through the first waveguide region so that the first and second sealing layers are heat-fused each other to be sealed.

2. The pouch sealing device of claim 1, wherein the first waveguide comprises a flat upper side and a flat lower side opposite the upper side and in close contact with the first insulating layer of the first pouch, and
wherein the first waveguide region penetrates the upper side and the lower side, and the lower opening width of the first waveguide region is smaller than the upper opening width of the first waveguide region.

3. The pouch sealing device of claim 2, wherein the upper opening has a width of 1 mm to 7 mm and the lower opening has a width of 0.5 mm to 5 mm.

4. The pouch sealing device of claim 1, wherein the first laser bundle array includes a first incident fiber onto which a laser is incident from a laser generating device, a plurality of second emission fibers coupled to the first incident fibers through a first coupler, and a plurality of first legs coupled to the first waveguide region while being coupled to the second emission fibers, respectively.

5. The pouch sealing device of claim 1, further comprising a first micro lens and a first cylinder lens coupled to the first waveguide region.

6. The pouch sealing device of claim 1, wherein the laser has a wavelength of 700 nm to 1100 nm.

7. The pouch sealing device of claim 1, further comprising a second waveguide pressurizing the second pouch and having a second waveguide region; and
a second laser bundle array being coupled to the second waveguide and supplying a laser through the second waveguide region so that the first and second sealing layers are heat-fused to be sealed.

8. The pouch sealing device of claim 7, further comprising a distance sensor for sensing the sealing distance between the first waveguide and the second waveguide after the sealing,
wherein a non-contact pouch sealing device determines that the sealing has been performed to have an optimal sealing strength if the distance sensed by the distance sensor is within a preset reference distance range, it determines that weak sealing has been performed if the distance sensed by the distance sensor is greater than the preset reference distance range, and it determines that over-sealing has been performed if the distance sensed by the distance sensor is less than the preset reference distance range.
